(19) United States
(12) Patent Application Publication
(10) Pub. No.: US 2025/0256806 A1
(43) Pub. Date: Aug. 14, 2025

(54) BATTERY TERMINAL FOR TWO-WHEELED VEHICLES HAVING AN ELECTRIC DRIVE UNIT

(71) Applicant: ZF Friedrichshafen AG, Friedrichshafen (DE)

(72) Inventor: Jakob Lauhoff, Tübingen (DE)

(73) Assignee: ZF Friedrichshafen AG, Friedrichshafen (DE)

(21) Appl. No.: 18/702,430

(22) PCT Filed: Oct. 18, 2022
(86) PCT No.: PCT/EP2022/078889

§ 371 Date: Apr. 18, 2024

(30) Foreign Application Priority Data
Oct. 19, 2021 (DE) 10 2021 211 759.7

(51) Int. Cl. B62M 6/90; B60L 50/64; H01M 10/613; H01M 10/625; H01M 10/6551; H01M 50/249; H01M 50/262; H01M 50/296; H01R 13/66

(52) U.S. Cl. CPC B62M 6/90; B60L 50/64; H01M 10/613; H01M 10/625; H01M 10/6551; H01M 50/249; H01M 50/262; H01M 50/296; B62K 2204/00; H01M 2220/20; H01R 13/665; H01R 2201/26

(57) ABSTRACT

The invention relates to a battery terminal (30) for two-wheeled vehicles having an electric drive unit, more particularly e-bikes, which has a housing (31). A plug connection for the drive battery is located on the front side. A plug connector (36) for the drive unit and plug connectors (37a, 37b, 37c) for small loads are located on the rear side. A voltage converter for reducing the voltage of the drive battery to the supply voltage of the small loads sits in the housing (31). The voltage converter has a heat sink (41), which extends through an opening (34) in the housing (31) into the open. The waste heat of the voltage converter is thus kept away from the drive unit and from the drive battery. Also disclosed is an arrangement of electrical components for a two-wheeled vehicle.

### RELATED APPLICATIONS

This application claims the benefit under 35 U.S.C. § 371 as a U.S. National Phase Application of application no. PCT/EP2022/078889, filed on 18 Oct. 2022, which claims the benefit of German Patent Application no. 10 2021 211 759.7 filed on 19 Oct. 2021, the contents of which are hereby incorporated herein by reference in their entireties.

### FIELD OF THE DISCLOSURE

The invention relates to a battery terminal for two-wheeled vehicles having an electric drive unit, more particularly e-bikes, pedelecs, electric bicycles, electric motorcycles and scooters. The invention also relates to the arrangement of the electrical components of such a two-wheeled vehicle.

### SUMMARY

The electrical energy for the drive unit comes from a relatively large drive battery with a relatively high voltage of, e.g., 36 V or 48 V; comparatively high currents flow. In addition, smaller loads such as headlights, tail lights, remote controls on the handlebars with display or charging devices for cell phones must also be supplied with power from the drive battery. These small loads are usually operated at a lower voltage, usually 12 V. The small loads therefore cannot be connected directly to the high-voltage battery for the drive; a voltage converter must be connected in between, which reduces the voltage of the drive battery to the supply voltage of the small loads.

Very often, the voltage converter is installed in the drive unit, i.e., in the immediate vicinity of the electric motor. In this case, the result is an architecture in which the drive unit is a kind of distribution node to which all electrical loads, i.e., both the electric motor and small loads, are connected. If the drive unit is a comparatively large and heavy component and the number of small loads is low, this architecture is a proven and good solution, especially for e-bikes with a mid-motor layout. The vast majority of pedelecs are therefore built in this way.

The trend, however, is toward two-wheeled vehicles, especially e-bikes, with ever smaller drive units and an increasing number of additional electrical loads, including multifunctional electric circuits, heated grips, electric locks and control units with large screens. If the front or rear wheel is driven by a hub motor, it is not at all possible to connect the small loads to the drive unit for the purpose of power supply.

As an alternative to the arrangement of the voltage converter in the drive unit, there have long been architectures in which the voltage converter is located in the drive battery, together with the battery management system (BMS). This has the advantage that the drive unit (DU), including the electronic motor control unit, can be made smaller and more compact because it no longer has to include the interfaces and connection plugs for the small loads.

If the voltage converter is located in the drive battery, the individual small loads can of course no longer all be connected individually directly to the drive battery. Instead, the distribution function is shifted to a wiring harness. This architecture is particularly widespread for more powerful two-wheeled vehicles and electric motorcycles.

A DC/DC converter naturally generates a relatively large amount of heat loss. It is therefore problematic to install, in particular, voltage converters for higher outputs in the drive battery. This is because the battery cells react sensitively to higher temperatures, which inevitably occur in any case under heavy load from the electric drive unit and/or high charging currents when charging the battery. A further disadvantage of arranging the voltage converter in the drive battery is that the wiring harness required for a modular product such as a pedelec would result in an almost unmanageable variance due to different frame sizes, equipment variants, etc.

The technical problem is therefore to optimize the architecture of the electrical components of a two-wheeled vehicle having an electric drive unit in such a way that, on the one hand, it supports a larger number of small loads and, on the other hand, it can be designed in a simple modular way while keeping the dimensions of the drive unit as compact as possible and the overall weight as low as possible.

The problem is solved by a battery terminal according to the present disclosure.

The battery terminal according to the invention has a housing with a plug connection for connecting a drive battery, a plug connector for the electric drive unit and a number of other plug connectors for the small electrical loads. The voltage converter for reducing the voltage of the drive battery to the supply voltage of the small loads is located on or in the housing of the battery terminal. The voltage converter is therefore located neither in the drive unit nor in the drive battery, but where the discharge plug is normally located.

A first advantage of the battery terminal according to the invention is that neither the electric drive unit nor the drive battery is burdened with the waste heat from the voltage converter. A second advantage is that the battery terminal, which is physically separated from the drive battery, also has space for a larger number of connectors or plug connections for a large number of small loads. This eliminates the need for a complex wiring harness with many branches and is replaced by simple, thin connecting cables that lead directly from the small loads to the battery terminal.

The approach according to the invention of not using up the limited installation space for the drive unit or the drive battery for the voltage converter, but instead accommodating the voltage converter in a place where there is enough space, namely between the drive unit and the drive battery, results in particularly good space economy and simplifies the design of the two-wheeled vehicle. The waste heat from the voltage converter also does not interfere at this point and can be dissipated into the surrounding environment without any problems.

In principle, the battery terminal with integrated voltage converter can be mounted anywhere on the two-wheeled vehicle. However, a design is preferred in which the housing has a front side on which the plug connection for the drive battery is arranged and a rear side on which the plug connector for the traction unit and the plug connectors for the small loads are arranged. The plug connection for the drive battery can either be a purely electrical connection or at the same time be designed as a mechanical connection between the housing of the battery terminal and the drive battery or its housing. It is essential that the battery terminal is a separate module from the drive battery.

The voltage converter arranged on or preferably in the housing advantageously has a heat sink for dissipating the heat loss. Depending on the size and power of the voltage converter, it may be sufficient for the waste heat from the heat sink to be dissipated outwardly via the wall of the housing. In a particularly advantageous embodiment, however, the heat sink of the voltage converter protrudes out of an opening in the housing into the open, so that even larger amounts of heat can be effectively dissipated.

Since, as explained, the drive battery should preferably not be additionally burdened with waste heat, the opening for the heat sink is conveniently arranged on the rear side of the housing, that is to say on the side facing away from the drive battery. The rear side of the housing can substantially be formed by a frame that surrounds the opening for the heat sink. As a result, the voltage converter is optimally cooled, and the heat sink protruding outwards does not interfere at this point and is optimally positioned in the airstream. The plug connectors for the electric drive unit and/or the small electrical loads are conveniently located on this frame, whereby the heat sink protruding from the middle makes optimum use of the available overall length.

The drive batteries for electrified two-wheeled vehicles usually have an elongate shape and a cross-sectional profile that is matched to the frame profile. The housing of the battery terminal is therefore also preferably adapted to the cross-sectional shape of the drive battery, so that the battery terminal appears as a unit when the drive battery is connected.

The relatively heavy and usually elongate drive battery is often fixed to a mounting rail, which can be attached to the frame of the two-wheeled vehicle, for example using screws. Advantageously, the battery terminal also sits on this mounting rail or a correspondingly formed extension. This eliminates the need for additional mounting means to attach it to the frame of the two-wheeled vehicle.

The housing of the battery terminal can be designed in such a way that it forms a form-fitting connection with the front side of the drive battery. As a result, the battery terminal acts like an extension of the drive battery and thus integrates very well into the design of the two-wheeled vehicle. In addition, the battery terminal is also part of the fastening mechanism of the drive battery.

The technical problem described is also solved by an arrangement as disclosed herein. The arrangement according to the invention comprises all electrical components of the two-wheeled vehicle, i.e., electrical drive unit, drive battery, small loads and battery terminal arranged between drive battery and drive unit, at or in which the voltage converter for reducing the voltage of the drive battery to the supply voltage of the small loads is arranged.

### BRIEF DESCRIPTION OF THE DRAWINGS

An exemplary embodiment of the invention is explained below with reference to the attached figures, in which:

FIG. 1 shows an arrangement of the electrical components of a two-wheeled vehicle, in a schematic diagram;

FIG. 2a shows a battery terminal with voltage converter according to the arrangement in FIG. 1, in a perspective view obliquely from the front;

FIG. 2b shows the rear side of the battery terminal from FIG. 2a, in a perspective view.

### DETAILED DESCRIPTION

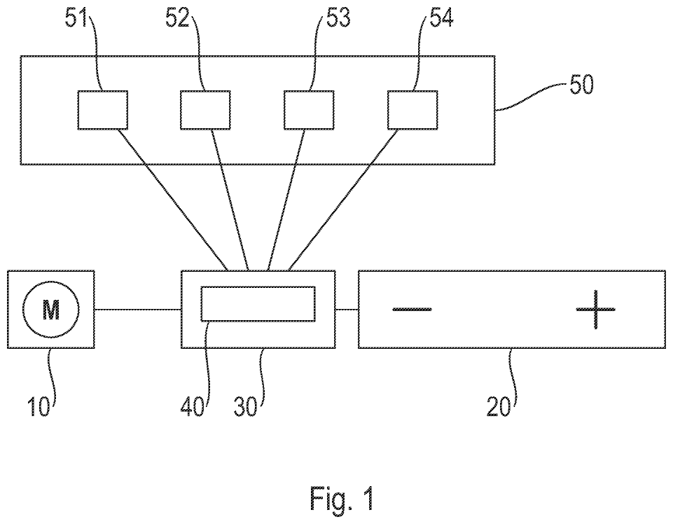

The schematic diagram in FIG. 1 shows an example of the electrical components of a pedelec (pedal electric cycle). The arrangement comprises a drive unit 10 consisting of a DC motor and the associated power electronics. A drive battery 20 supplies the drive unit 10 with energy. The drive unit 10 comprises a number of battery cells and an electronic battery management system (BMS), which are accommodated together in a compact housing. The drive battery 20 is arranged on the frame of the pedelec at some distance from the drive unit 10. The drive unit 10 is designed as a mid-motor layout, for example, and is located directly on the crank of the bicycle as part of the bottom bracket, whereas the drive battery is detachably fastened to the down tube of the frame, for example.

A battery terminal 30 is arranged between the drive unit 10 and the drive battery 20. A voltage converter 40 is integrated in the battery terminal 30.

Several small loads 50, in this example a headlight 51, a tail light 52, a remote control 53 for controlling and monitoring the drive unit 10, and a further electronic circuit 54, are electrically connected directly to the battery terminal 30.

For example, the drive battery 20 has a nominal voltage of 48 V. The voltage converter 40 is used to reduce the voltage to the supply voltage of the small loads 50, i.e., usually 12 V.

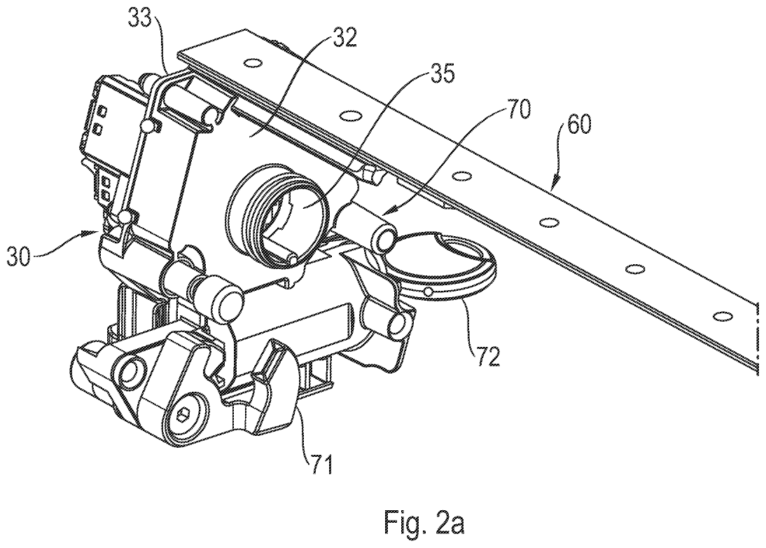

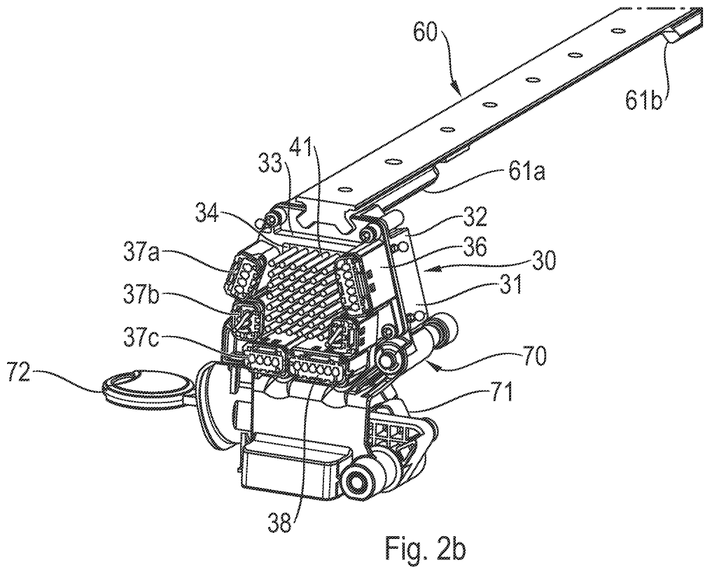

Design details of the battery terminal 30 are shown in FIGS. 2a and 2b.

The battery terminal 30 has a two-part housing 31 consisting of a trough-like lower part 32 and a screwed-on upper part in the form of a frame 33. The frame 33 substantially forms the rear side of the housing 31 and frames a large angular opening 34. The voltage converter 40 (not visible here) is located inside the housing 31. In FIG. 2a, only the heat sink 41 of the voltage converter 40 can be seen, which protrudes from the opening 34 in the frame 33 so that it is in contact with the surrounding air.

A plug connection 35 is located in the lower part 32 on the rear side of the housing 31 and is used both to establish the electrical contact with the electronics of the drive battery 20 (see FIG. 1) and also to connect the housing of the drive battery 20 mechanically to the battery terminal 30. There is also a plug connector 36 on the rear side of the housing 31 (FIG. 2a), via which the drive unit 10 (see FIG. 1) can be electrically connected to the drive battery 20. Further plug connectors 37a, 37b, 37c are used for the electrical connection of the small loads 50 (cf. FIG. 1). A connection plug 38 is connected to a charging socket (not shown) for charging the drive battery 20. The plug connector 36, the other plug connectors 37a, 37b, 37c and the connection plug 38 are arranged at the edge of the housing 31 on the frame 33 so that they surround the centrally arranged heat sink 41.

The battery terminal 30 is located on the underside of a mounting rail 60, which can be bolted to the frame of the two-wheeled vehicle. Dovetail-shaped fixing elements 61a, 61b are formed on this mounting rail 60, onto which the drive battery 20 (not shown) can be slid.

The contour of the housing 31 of the battery terminal 30 is adapted to the cross-sectional shape of the drive battery 20. A holder 70 for the drive battery and a locking device 71 with key 72 are connected to the housing 31.

### LIST OF REFERENCE SIGNS

10 drive unit
20 drive battery
30 battery terminal
31 housing
32 lower part (housing)
33 frame (housing)
34 opening
35 plug connection (drive battery)
36 plug connector (drive unit)
37a, 37b, 37c plug connectors (small loads)
38 connection plug
40 voltage converter
41 heat sink
50 small loads
51 headlight
52 tail light
53 remote control
54 electronic circuit
60 mounting rail
61a, 61b fixing elements
70 holder (drive battery)
71 locking device
72 key

1. A battery terminal for two-wheeled vehicles having an electric drive unit, the battery terminal comprising:
a housing (31) with a plug connection (35) for connecting a drive battery (20);
a plug connector (36) for the electric drive unit (10);
one or more plug connectors (37a, 37b, 37c) for small electrical loads (50); and
a voltage converter (40) arranged on or in the housing (31), the voltage converter configured for reducing a voltage of the drive battery (20) to a supply voltage of the small electrical loads (50).

2. The battery terminal as claimed in claim 1, wherein the housing (31) has a front side, on which the plug connection (35) for the drive battery (20) is arranged, and a rear side, on which the plug connector (36) for the drive unit (10) and the one or more plug connectors (37a, 37b, 37c) for the small electrical loads (50) are arranged.

3. The battery terminal as claimed in claim 1, wherein the voltage converter (40) has a heat sink (41) for dissipating the heat loss.

4. The battery terminal as claimed in claim 3, wherein the heat sink (41) protrudes through an opening (34) in the housing (31) into the open.

5. The battery terminal as claimed in claim 4, wherein the opening (34) for the heat sink (41) is arranged on the rear side of the housing (31).

6. The battery terminal as claimed in claim 5, wherein the rear side of the housing (31) is substantially formed by a frame (33) which surrounds the opening (34) for the heat sink (41).

7. The battery terminal as claimed in claim 6, wherein the plug connectors (36, 37a, 37b, 37c) are arranged on the frame (33) around the heat sink (41).

8. The battery terminal as claimed in claim 1, further comprising the drive battery, wherein the contour of the housing (31) is adapted to the cross-sectional shape of the drive battery (20).

9. The battery terminal as claimed in claim 8, wherein the housing (31) sits on a mounting rail (60) configured to be fastened to the frame of the two-wheeled vehicle, and the mounting rail has fixing elements (61a, 61b) for detachably fastening the drive battery (20).

10. The battery terminal as claimed in claim 9, wherein the housing (31) is configured for a form-fitting connection to the drive battery (20).

11. An arrangement of electrical components of a two-wheeled vehicle, comprising:
an electric drive unit (10);
a drive battery (20);
one or more small electrical loads (50); and
a battery terminal (30) arranged between drive battery and the electric drive unit, the battery terminal having an integrated voltage converter (40) configured for reducing a voltage of the drive battery (20) to a supply voltage of the one or more small electrical loads (50).
